(19) United States
(12) Patent Application Publication
(10) Pub. No.: US 2014/0206823 A1
(43) Pub. Date: Jul. 24, 2014

(54) METHOD FOR REDUCING THE HALOGEN CONTENT OF A POLYMER

(71) Applicants: Mandi J. McElwain, Glenside, PA (US); Christopher Paul Radano, West Chester, PA (US); Nadine Iroff, Perkiomenville, PA (US); Peter Moore, Singapore (SG)

(72) Inventors: Mandi J. McElwain, Glenside, PA (US); Christopher Paul Radano, West Chester, PA (US); Nadine Iroff, Perkiomenville, PA (US); Peter Moore, Singapore (SG)

(73) Assignee: Evonik Oil Additives GmbH, Darmstadt (DE)

(21) Appl. No.: 14/131,086

(22) PCT Filed: Jul. 3, 2012
(86) PCT No.: PCT/EP2012/062885

§ 371 Date: Jan. 6, 2014

Related U.S. Application Data
(60) Provisional application No. 61/527,800, filed on Aug. 26, 2011.

(51) Int. Cl. C08F 220/18

(52) U.S. Cl. CPC C08F 220/18
USPC 525/330.5; 525/330.3

(57) ABSTRACT

The invention relates to a method for reducing the halogen content of a polymer, characterized in that the polymer is reacted with a polymerization inhibitor; and especially to a method wherein said polymer is a polymerization product of an ATRP process.

The present invention relates to a method for reducing the halogen content of a polymer.

Based on cost effectiveness, free-radical polymerization is used to polymerize ethylenically unsaturated monomers. A disadvantage is that the structure of the polymers, the molecular weight and the molecular distribution is relatively difficult to control.

A solution to these problems is provided by the general class of reactions known as ‘Controlled Radical Polymerizations’. This class includes both the ATRP (=atom transfer radical polymerization) process and more recently, the RTCP (=reversible chain transfer catalyzed polymerization) process.

More specifically, ATRP is an important process for preparation of a wide variety of polymers, e.g. polyacrylates, polymethacrylates or polystyrenes. This type of polymerization has provided considerable progress toward the objective of tailored polymers.

The halogen atom, which remains at the respective chain ends after termination of the reaction, can allow for sequential addition of further monomer fractions for the construction of block structures or serve as macroinitiator after purification and thus allow further polymer formation. Alternatively, it can serve as a site for further functionalization of the resulting polymer.

However, in many final applications, the presence of halogen in the polymer product can be detrimental. In addition, tightening environmental regulations in many areas restrict the presence of halogens and organo-halogens in commercial chemical products.

Additionally, it is well known that these halogen-functionalized polymers are thermally unstable, wherein in particular polymethacrylates and polyacrylates have been found to be markedly susceptible to depolymerization when terminal halogen atoms are present.

A method for efficient removal of said terminal halogen atoms from polymers produced via ATRP is therefore of great interest.

There have been already different approaches to provide methods to reduce the concentration of halogen in the final polymer compositions.

U.S. Pat. No. 6,689,844 B2 discloses a process for synthesis of polymer compositions with reduced living halogen content, wherein ethylenically unsaturated monomers are polymerized by means of initiators containing a transferable halogen and of one or more catalysts comprising at least one transition metal in the presence of ligands which can form a coordination compound with the metal catalyst or catalysts. After polymerization, the living halogen atoms present in the polymer are at least partly eliminated, wherein after the polymerization, the polymer composition is reacted with at least one polydentate organic nitrogen compound in the presence of a nonpolar solvent.

However, the use of high concentrations of aliphatic nitrogen compounds as disclosed therein (for ex. N,N,N′,N′,N″-pentamethyldiethylenetriamine (PMDETA)) to reduce the halogen content to values ranging from ˜50 to ˜900 ppm (based on the examples in the patent) lead to a high final nitrogen content in the final polymer which can be disadvantageous for some applications. In addition, the use of such high amounts of said compounds is very expensive and can therefore lead to an economic loss even if the chemical reaction itself would serve the purpose.

US 2009/0275707 A1 discloses a process for the removal of halogens atoms from polymers and removal of transition metal compounds wherein the halogen atoms are substituted by addition of a suitable sulfur compound and simultaneously the transition metal compounds are precipitated by said sulfur compound, and are then removed by filtration. In a special embodiment of the disclosed invention an ATRP process is as well comprised as polymerization process.

However, the use of sulfur compounds such as alkyl mercaptans to displace the halogen from the polymer chain end introduces sulfur into the polymer, which can be again disadvantageous for certain specific applications, especially due to the fact that unreacted mercaptans molecules import a distinctive and undesired sulfur odor to the polymer.

Although there have been already some very promising approaches accessible in the known prior art to reduce the halogen content in a final polymer, there is still need to further improve said methods.

In view of the prior art, it was now an object of the present invention to provide processes for synthesis of polymer compositions with reduced halogen content, wherein the living halogen atom at the active chain end should be substantially removed.

Furthermore, the halogen at the end of the polymers should be removed without the incorporation of sulfur in the polymeric chain.

Additionally, the polymer post reaction treatment should be reproducible in a simple and inexpensive manner, and especially commercially available components should be used. In this context, they should be producible on the industrial scale without new plants or plants of complicated construction being required for this purpose.

A very particular objective is to carry out the halogen removal directly at the end of the actual ATRP process in the same reaction vessel (one-pot reaction) without additional product work-up.

Furthermore, broadening of the molecular-weight distribution of the polymer composition should be prevented by the reaction.

A further object of the present invention was to provide, for synthesis of polymer compositions with reduced halogen content, a process in which decomposition of the polymers contained in the composition is prevented.

A further object was to find polymer compositions which have an excellent spectrum of properties, so that they can be added as an ideal additive to lubricating oils.

This means among other requirements that the polymers contained in the composition have low sensitivity to oxidation and high resistance to shear loads.

In particular, the polymers contained in the polymer composition must have a narrow molecular-weight distribution and be substantially halogen-free.

These objects and also further objects which are not stated explicitly but are immediately derivable or discernable from the connections discussed herein by way of introduction are achieved by a method having all features of claim 1. Appropriate modifications to the method are protected in the claims referring back to claim 1.

The present invention accordingly provides a method for reducing the halogen content of a polymer characterized in that the polymer is reacted with a polymerization inhibitor.

The present method provides a high efficiency possibility to reduce the halogen content of a polymer without incorporating undesired groups into the final polymeric chain.

This type of method can be achieved particularly inexpensively and in this regard is of industrial interest.

Surprisingly, the present method can carry out the halogen removal without additional product work-up directly at the end of the actual ATRP process in the same reaction vessel (one-pot reaction).

The narrow distribution of the polymers synthesized can be maintained during the inventive method to reduce the total halogen content in the polymer.

The inventive method permits excellent control of the active chain end of the polymer during the process to reduce the halogen content in the polymer. Thus, an undesired broadening of the molecular weight distribution of the polymer can be avoided.

The method can be performed with relatively few problems as regards pressure, temperature and solvent, acceptable results being obtained under certain circumstances even at moderate temperatures.

The polymer is decomposed not at all or only slightly by the process.

The present method for reducing the halogen content of a polymer includes the reaction with a polymerization inhibitor. The polymerization inhibitor used in the inventive method is in the general class known as free radical inhibitors and/or antioxidants. More specifically the inhibitors used are well known as effective polymerization inhibitors used throughout the industry for the preparation and/or synthesis of a variety of monomers, including but not limited to styrene, vinyl acetate, alkyl methacrylates, alkyl acrylates. According to a preferred embodiment the polymerization inhibitor may have about the same efficiency as inhibitor with regard to methyl methacrylate as hydroquinone at a treat rate of at least 50 ppm, more preferably at a treat rate of at least 100 ppm wherein the treat rate of the polymerization inhibitor is at most 500 ppm, more preferably at most 300 ppm.

The polymerization inhibitors are generally commercially available. For more details it is herein referred to known prior art, in particular to Römpp-Lexikon Chemie; Editor: J. Falbe, M. Regitz; Stuttgart, N.Y.; 10. version (1996); keyword “antioxidants” and the at this site cited literature references.

In a preferred embodiment of the invention, the polymerization inhibitor is an aromatic compound. These aromatic compounds comprise phenolic compounds; especially steric hindered phenols, such as 2,4-dimethyl-6-tert-butylphenol or 2,6-ditert-butyl-4-methylphenol; and/or tocopherol-compounds, preferably α-tocopherol.

Especially preferred phenolic compounds are hydroquinones, such as tert-butylhydroquinone, 2,6-di-tert-butylhydroquinone, 2,5-di-tert-butylhydroquinone, 2,4-dimethyl-6-tert-butylphenol or di-tert-butylbrenzcatechine, and hydroquinone ethers, such as hydroquinone monomethylether.

In a preferred embodiment of the invention, the polymerization inhibitor is a nitrogen containing compound. Organic nitrogen compounds being useful as polymerization inhibitor are known in themselves. Besides one or more nitrogen atoms, they contain alkyl, cycloalkyl or aryl groups, and the nitrogen atom may also be a member of a cyclic group.

These inhibitors comprise amines, such as thiodiphenylamine and phenothiazine; and/or p-phenylene diamines, such as N,N′-diphenyl-p-phenylene diamine, N,N′-di-2-naphthyl-p-phenylene diamine, N,N′-di-p-tolyl-p-phenylene diamine, N-1,3-dimethylbutyl-N′-phenyl-p-phenylene diamine and N-1,4-dimethylpentyl-N′-phenyl-p-phenylene diamine.

Preferably, the nitrogen containing compound representing the polymerization inhibitor herein is a nitroso compound, such as nitrosodiphenylamine, isoamylnitrite, N-nitrosocyclohexylhydroxylamine, N-nitroso-N-phenyl-N-hydroxylamine and their salts, especially their alkali and ammonium salts such as cupferron (N-nitroso-N-phenyl-N-hydroxylamine ammonium salt).

More preferably, the nitrogen containing compound representing the polymerization inhibitor herein is a N-oxyl compound, such as 2,2,4,4-tetramethylazetidin-1-oxyl, 2,2-dimethyl-4,4-dipropylazetidin-1-oxyl, 2,2,5,5-tetramethylpyrrolidin-1-oxyl, 2,2,5,5-tetramethyl-3-oxopyrrolidin-1-oxyl, 2,2,6,6-tetramethylpiperidin-1-oxyl (TEMPO), 4-hydroxy-2,2,6,6-tetramethylpiperidin-1-oxyl(4-Hydroxy-TEMPO), 6-Aza-7,7-dimethyl-spiro[4,5]decan-6-oxyl, 2,2,6,6-tetramethyl-4-acetoxypiperidin-1-oxyl and/or 2,2,6,6-tetramethyl-4-benzoyloxypiperidin-1-oxyl.

Preferably, the polymerization inhibitor can comprise a stabilized radical. Examples of these stabilized radical inhibitors are nitroso compounds and N-oxyl compounds as mentioned above.

Most preferred are N-oxyl compound having a hydroxyl group such as 4-hydroxy-2,2,6,6-tetramethylpiperidin-1-oxyl.

The polymerization inhibitors can be used individually or as a mixture.

Within the context of the present invention, all ranges below include explicitly all subvalues between the upper and lower limits.

The present method for reducing the halogen content is not limited to specific polymer types but can be performed with any polymer, including the polymers mentioned above and below with regard to ATRP polymerization. These polymers include e.g. polystyrenes, polyacrylamide and ester group containing polymers such as polyacrylates and polymethacrylates.

The number-average molecular weight Mₙ may preferably be in the range from 2000 to 1 000 000 g/mol, especially from 5000 to 800 000 g/mol, more preferably 7500 to 500 000 g/mol and most preferably 10 000 to 80 000 g/mol.

Of particular interest, among others, are polymers which comprise ester groups and preferably have a weight-average molecular weight M_{w} in the range from 2000 to 2 000 000 g/mol, especially from 7500 to 1 000 000 g/mol, more preferably 10 000 to 600 000 g/mol and most preferably 15 000 to 80 000 g/mol.

According to a special embodiment of the present invention, the ester group containing polymer, preferably a polyalkyl(meth)acrylat may have a weight-average molecular weight M_{w} in the range from 2000 to 1 000 000 g/mol, especially from 20 000 to 800 000 g/mol, more preferably 40 000 to 500 000 g/mol and most preferably 60 000 to 250 000 g/mol.

According to a further aspect of the present invention, the ester group containing polymer, preferably a polyalkyl(meth)acrylat may have a number average molecular weight Mₙ in the range from 2 000 to 100 000 g/mol, especially from 4 000 to 60 000 g/mol and most preferably 5 000 to 30 000 g/mol.

Without intending any limitation by the following description, the polymers which comprise ester groups preferably exhibit a polydispersity, given by the ratio of the weight average molecular weight to the number average molecular weight Mw/Mn, in the range of 1 to 15, more preferably 1.1 to 10, especially preferably 1.2 to 5. The polydispersity may be determined by gel permeation chromatography (GPC).

The polymer comprising ester groups may have a variety of structures. For example, the polymer may be present as a diblock, triblock, multiblock, comb and/or star copolymer which has corresponding polar and nonpolar segments. In addition, the polymer may especially be present as a graft copolymer.

Polymers comprising ester groups are understood in the context of the present invention to mean polymers obtainable by polymerizing monomer compositions which comprise ethylenically unsaturated compounds having at least one ester group, which are referred to hereinafter as ester monomers. Ester monomers are known per se. They include especially (meth)acrylates, maleates and fumarates, which may have different alcohol radicals. The expression “(meth)acrylates” encompasses methacrylates and acrylates, and mixtures of the two. These monomers are widely known. Accordingly, these polymers contain ester groups as part of the side chain.

The polymer comprising ester groups can be used singly or as a mixture of polymers having different molecular weights, different compositions of repeating units and/or different ester group containing monomers, for example.

The polymer comprising ester groups comprises preferably at least 40% by weight, more preferably at least 60% by weight, especially preferably at least 80% by weight and most preferably at least 90% by weight of repeat units derived from ester monomers.

According to a preferred embodiment of the present invention, polyalkyl(meth)acrylates (PAMAs), polyalkyl fumarates and/or polyalkyl maleates are included.

Ester monomers for the manufacture of polyalkyl(meth)acrylates (PAMAs), polyalkyl fumarates and/or polyalkyl maleates are known per se. They include especially (meth)acrylates, maleates and fumarates, which may have different alcohol parts. The expression “(meth)acrylates” includes methacrylates and acrylates, and mixtures of the two. These monomers are widely known. In this context, the alkyl part may be linear, cyclic or branched. The alkyl part may also have known substituents.

The term “repeating unit” is widely known in the technical field. The present polymers comprising ester groups can preferably be obtained by means of free-radical polymerization of monomers or the controlled radical process technique of ATRP. Accordingly, the repeat unit is obtained from the monomers used.

The polymers comprising ester groups preferably contain repeating units derived from ester monomers having 7 to 4000 carbon atoms in the alcohol part. Preferably, the polymer comprises at least 40% by weight, especially at least 60% by weight and more preferably at least 80% by weight of repeating units derived from ester monomers having 7 to 4000 carbon atoms, preferably 7 to 300 carbon atoms and more preferably 7 to 30 carbon atoms in the alcohol part.

According to a preferred embodiment the polymer may comprise repeating units derived from ester monomers having 16 to 4000 carbon atoms, preferably 16 to 300 carbon atoms and more preferably 16 to 30 carbon atoms in the alcohol part, and repeating units derived from ester monomers having 7 to 15 carbon atoms in the alcohol part.

The polymer comprising ester groups may contain 5 to 100% by weight, especially 20 to 98% by weight and more preferably 50 to 90% by weight of repeat units derived from ester monomers having 7 to 15 carbon atoms in the alcohol part.

In a particular aspect, the polymer comprising ester groups may contain 0 to 90% by weight, preferably 5 to 80% by weight and more preferably 40 to 70% by weight of repeat units derived from ester monomers having 16 to 4000, preferably 16 to 30 carbon atoms in the alcohol part.

Preferably, the polymer may comprise repeating units derived from ester monomers having 23 to 4000 carbon atoms, preferably 23 to 400 carbon atoms and more preferably 23 to 300 carbon atoms in the alcohol part.

In addition, the polymer comprising ester groups may contain 0.1 to 60% by weight, especially 0.5 to 40% by weight, preferably 1 to 30% by weight and more preferably 2 to 25% by weight, of repeat units derived from ester monomers having 1 to 6 carbon atoms in the alcohol part.

According to a preferred embodiment the polymer may comprise repeating units derived from ester monomers having 23 to 4000 carbon atoms, preferably 23 to 400 carbon atoms and more preferably 23 to 300 carbon atoms in the alcohol part, and repeating units derived from ester monomers having 1 to 6 carbon atoms in the alcohol part.

The polymer comprising ester groups comprises preferably at least 40% by weight, more preferably at least 60% by weight, especially preferably at least 80% by weight and very particularly at least 95% by weight of repeat units derived from ester monomers.

Mixtures from which the inventive polymers comprising ester groups are obtainable may contain 0 to 40% by weight, especially 0.1 to 30% by weight and more preferably 0.5 to 20% by weight of one or more ethylenically unsaturated ester compounds of the formula (I)

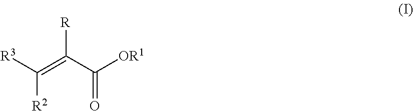

in which R is hydrogen or methyl, R¹ is a linear or branched alkyl radical having 1 to 6 carbon atoms, R² and R³ are each independently hydrogen or a group of the formula —COOR′ in which R′ is hydrogen or an alkyl group having 1 to 6 carbon atoms.

Examples of component (I) include

(meth)acrylates, fumarates and maleates which derive from saturated alcohols, such as methyl(meth)acrylate, ethyl(meth)acrylate, n-propyl(meth)acrylate, isopropyl(meth)acrylate, n-butyl(meth)acrylate, tert-butyl(meth)acrylate and pentyl(meth)acrylate, hexyl(meth)acrylate;
cycloalkyl(meth)acrylates, such as cyclopentyl(meth)acrylate, cyclohexyl(meth)acrylate.

The compositions to be polymerized preferably contain 0 to 100% by weight, particularly 5 to 98% by weight, especially 20 to 90% by weight and more preferably 50 to 90% by weight of one or more ethylenically unsaturated ester compounds of the formula (II)

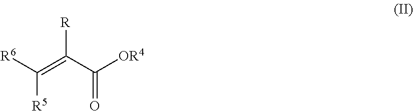

in which R is hydrogen or methyl, R⁴ is a linear or branched alkyl radical having 7 to 15 carbon atoms, R⁵ and R⁶ are each independently hydrogen or a group of the formula —COOR″ in which R″ is hydrogen or an alkyl group having 7 to 15 carbon atoms.

Examples of component (II) include:

(meth)acrylates, fumarates and maleates which derive from saturated alcohols, such as 2-ethylhexyl(meth)acrylate, heptyl(meth)acrylate, 2-tert-butylheptyl(meth)acrylate, octyl(meth)acrylate, 3-isopropylheptyl(meth)acrylate, nonyl(meth)acrylate, decyl(meth)acrylate, 2-Propyl heptyl(meth)acrylate, undecyl(meth)acrylate, 5-methylundecyl(meth)acrylate, dodecyl(meth)acrylate, 2-methyldodecyl(meth)acrylate, tridecyl(meth)acrylate, 5-methyltridecyl(meth)acrylate, tetradecyl(meth)acrylate, pentadecyl(meth)acrylate;
(meth)acrylates which derive from unsaturated alcohols, for example oleyl(meth)acrylate;
cycloalkyl(meth)acrylates such as 3-vinylcyclohexyl(meth)acrylate, bornyl(meth)acrylate; and the corresponding fumarates and maleates.

In addition, preferred monomer compositions comprise 0 to 100% by weight, particularly 0.1 to 90% by weight, preferably 5 to 80% by weight and more preferably 40 to 70% by weight of one or more ethylenically unsaturated ester compounds of the formula (III)

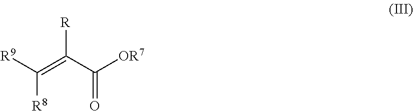

in which R is hydrogen or methyl, R⁷ is a linear or branched alkyl radical having 16 to 4000, preferably 16 to 400 and more preferably 16 to 30 carbon atoms, R⁸ and R⁹ are each independently hydrogen or a group of the formula —COOR′″ in which R′″ is hydrogen or an alkyl group having 16 to 4000, preferably 16 to 400 and more preferably 16 to 30 carbon atoms.

Examples of component (III) include (meth)acrylates which derive from saturated alcohols, such as hexadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)acrylate;

cycloalkyl(meth)acrylates such as 2,4,5-tri-t-butyl-3-vinylcyclohexyl(meth)acrylate, 2,3,4,5-tetra-t-butylcyclohexyl(meth)acrylate,
and the corresponding fumarates and maleates.

Furthermore, the monomers according formula (III) especially include long chain branched (meth)acrylates as disclosed inter alia in U.S. Pat. No. 6,746,993, filed Aug. 7, 2002 with the United States Patent Office (USPTO) having the application Ser. No. 10/212,784; and US 2004/077509, filed Aug. 1, 2003 with the United States Patent Office (USPTO) having the application Ser. No. 10/632,108. The disclosure of these documents, especially the (meth)acrylate monomers having at least 16, preferably at least 23 carbon atoms are enclosed herewith by reference.

In addition thereto, the C₁₆-C₄₀₀₀ alkyl(meth)acrylate monomers, preferably the C₁₆-C₄₀₀ alkyl(meth)acrylate monomers include polyolefin-based macromonomers. The polyolefin-based macromonomers comprise at least one group which is derived from polyolefins. Polyolefins are known in the technical field, and can be obtained by polymerizing alkenes and/or alkadienes which consist of the elements carbon and hydrogen, for example C₂-C₁₀-alkenes such as ethylene, propylene, n-butene, isobutene, norbornene, and/or C₄-C₁₀-alkadienes such as butadiene, isoprene, norbornadiene. The polyolefin-based macromonomers comprise preferably at least 70% by weight and more preferably at least 80% by weight and most preferably at least 90% by weight of groups which are derived from alkenes and/or alkadienes, based on the weight of the polyolefin-based macromonomers. The polyolefinic groups may in particular also be present in hydrogenated form. In addition to the groups which are derived from alkenes and/or alkadienes, the alkyl(meth)acrylate monomers derived from polyolefin-based macromonomers may comprise further groups. These include small proportions of copolymerizable monomers. These monomers are known per se and include, among other monomers, alkyl(meth)acrylates, styrene monomers, fumarates, maleates, vinyl esters and/or vinyl ethers. The proportion of these groups based on copolymerizable monomers is preferably at most 30% by weight, more preferably at most 15% by weight, based on the weight of the polyolefin-based macromonomers. In addition, the polyolefin-based macromonomers may comprise start groups and/or end groups which serve for functionalization or are caused by the preparation of the polyolefin-based macromonomers. The proportion of these start groups and/or end groups is preferably at most 30% by weight, more preferably at most 15% by weight, based on the weight of the polyolefin-based macromonomers.

The number-average molecular weight of the polyolefin-based macromonomers is preferably in the range from 500 to 50 000 g/mol, more preferably from 700 to 10 000 g/mol, in particular from 1500 to 8000 g/mol and most preferably from 2000 to 6000 g/mol.

In the case of preparation of the comb polymers via the copolymerization of low molecular weight and macromolecular monomers, these values arise through the properties of the macromolecular monomers. In the case of polymer-analogous reactions, this property arises, for example, from the macroalcohols and/or macroamines used taking account of the converted repeat units of the main chain. In the case of graft copolymerizations, the proportion of polyolefins formed which have not been incorporated into the main chain can be used to conclude the molecular weight distribution of the polyolefin.

The polyolefin-based macromonomers preferably have a low melting point, which is measured by means of DSC. The melting point of the polyolefin-based macromonomers is preferably less than or equal to −10° C., especially preferably less than or equal to 20° C., more preferably less than or equal to −40° C. Most preferably, no DSC melting point can be measured for the repeat units which are derived from the polyolefin-based macromonomers in the polyalkyl(meth)acrylate copolymer.

Polyolefin-based macromonomers are disclosed in the publications DE 10 2007 032 120 A1, filed Jul. 9, 2007 at the German Patent Office (Deutsches Patentamt) having the application number DE102007032120.3; and DE 10 2007 046 223 A1, filed Sep. 26, 2007 at the German Patent Office (Deutsches Patentamt) having the application number DE 102007046223.0; which documents are enclosed herein by reference.

The ester compounds with a long-chain alcohol part, especially components (II) and (III), can be obtained, for example, by reacting (meth)acrylates, fumarates, maleates and/or the corresponding acids with long-chain fatty alcohols, which generally gives rise to a mixture of esters, for example (meth)acrylates with different long-chain hydrocarbons in the alcohol parts. These fatty alcohols include Oxo Alcohol® 7911, Oxo Alcohol® 7900, Oxo Alcohol® 1100; Alfol® 610, Alfol® 810, Lial® 125 and Nafol® types (Sasol); Alphanol® 79 (ICI); Epal® 610 and Epal® 810 (Afton); Linevol® 79, Linevol® 911 and Neodol® 25E (Shell); Dehydad®, Hydrenol® and Lorol® types (Cognis); Acropol® 35 and Exxal® 10 (Exxon Chemicals); Kalcol® 2465 (Kao Chemicals).

Among the ethylenically unsaturated ester compounds, the (meth)acrylates are particularly preferred over the maleates and fumarates, i.e. R², R³, R⁵, R⁶, R⁸ and R⁹ of the formulae (I), (II) and (III) in particularly preferred embodiments are each hydrogen.

The weight ratio of units derived from ester monomers having 7 to 15 carbon atoms, preferably of the formula (II), to the units derived from ester monomers having 16 to 4000 carbon atoms, preferably of the formula (III), may be within a wide range. The weight ratio of repeat units derived from ester monomers having 7 to 15 carbon atoms in the alcohol part to repeat units derived from ester monomers having 16 to 4000 carbon atoms in the alcohol part is preferably in the range from 30:1 to 1:30, more preferably in the range from 5:1 to 1:5, especially preferably 3:1 to 1.1:1.

The polymer may contain units derived from comonomers as an optional component. These comonomers include

aryl(meth)acrylates like benzyl(meth)acrylate or phenyl(meth)acrylate, where the acryl residue in each case can be unsubstituted or substituted up to four times;
(meth)acrylates of halogenated alcohols like 2,3-dibromopropyl(meth)acrylate, 4-bromophenyl(meth)acrylate, 1,3-dichloro-2-propyl(meth)acrylate, 2-bromoethyl(meth)acrylate, 2-iodoethyl(meth)acrylate, chloromethyl(meth)acrylate;
nitriles of (meth)acrylic acid and other nitrogen-containing (meth)acrylates like N-(methacryloyloxyethyl)diisobutylketimine, N-(methacryloyloxyethyl)dihexadecylketimine, (meth)acryloylamidoacetonitrile, 2-methacryloyloxyethylmethylcyanamide, cyanomethyl(meth)acrylate;
vinyl halides such as, for example, vinyl chloride, vinyl fluoride, vinylidene chloride and vinylidene fluoride;
vinyl esters like vinyl acetate;
vinyl monomers containing aromatic groups like styrene, substituted styrenes with an alkyl substituent in the side chain, such as α-methylstyrene and α-ethylstyrene, substituted styrenes with an alkyl substituent on the ring such as vinyltoluene and p-methylstyrene, halogenated styrenes such as monochlorostyrenes, dichlorostyrenes, tribromostyrenes and tetrabromostyrenes;
vinyl and isoprenyl ethers;
maleic acid and maleic acid derivatives such as mono- and diesters of maleic acid, maleic anhydride, methylmaleic anhydride, maleinimide, methylmaleinimide;
fumaric acid and fumaric acid derivatives such as, for example, mono- and diesters of fumaric acid;
methacrylic acid and acrylic acid.

According to a special aspect of the present invention, the ester group containing polymer comprises dispersing monomers.

Dispersing monomers are understood to mean especially monomers with functional groups, for which it can be assumed that polymers with these functional groups can keep particles, especially soot particles, in solution (cf. R. M. Mortier, S. T. Orszulik (eds.): “Chemistry and Technology of Lubricants”, Blackie Academic & Professional, London, 2^{nd} ed. 1997). These include especially monomers which have boron-, phosphorus-, silicon-, sulfur-, oxygen- and nitrogen-containing groups, preference being given to oxygen- and nitrogen-functionalized monomers.

Appropriately, it is possible to use especially heterocyclic vinyl compounds and/or ethylenically unsaturated, polar ester compounds of the formula (IV)

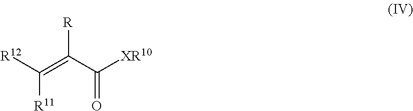

in which R is hydrogen or methyl, X is oxygen, sulfur or an amino group of the formula —NH— or —NR^{a}— in which R^{a} is an alkyl radical having 1 to 40 and preferably 1 to 4 carbon atoms, R¹⁰ is a radical which comprises 2 to 1000, especially 2 to 100 and preferably 2 to 20 carbon atoms and has at least one heteroatom, preferably at least two heteroatoms, R¹¹ and R¹² are each independently hydrogen or a group of the formula —COX′R^{10′} in which X′ is oxygen or an amino group of the formula —NH— or NR^{a′}— in which R^{a′} is an alkyl radical having 1 to 40 and preferably 1 to 4 carbon atoms, and R^{10′} is a radical comprising 1 to 100, preferably 1 to 30 and more preferably 1 to 15 carbon atoms, as dispersing monomers.

The expression “radical comprising 2 to 1000 carbon” denotes radicals of organic compounds having 2 to 1000 carbon atoms. Similar definitions apply for corresponding terms. It encompasses aromatic and heteroaromatic groups, and alkyl, cycloalkyl, alkoxy, cycloalkoxy, alkenyl, alkanoyl, alkoxycarbonyl groups, and also heteroaliphatic groups. The groups mentioned may be branched or unbranched. In addition, these groups may have customary substituents. Substituents are, for example, linear and branched alkyl groups having 1 to 6 carbon atoms, for example methyl, ethyl, propyl, butyl, pentyl, 2-methylbutyl or hexyl; cycloalkyl groups, for example cyclopentyl and cyclohexyl; aromatic groups such as phenyl or naphthyl; amino groups, hydroxyl groups, ether groups, ester groups and halides.

According to the invention, aromatic groups denote radicals of mono- or polycyclic aromatic compounds having preferably 6 to 20 and especially 6 to 12 carbon atoms. Heteroaromatic groups denote aryl radicals in which at least one CH group has been replaced by N and/or at least two adjacent CH groups have been replaced by S, NH or O, heteroaromatic groups having 3 to 19 carbon atoms.

Aromatic or heteroaromatic groups preferred in accordance with the invention derive from benzene, naphthalene, biphenyl, diphenyl ether, diphenylmethane, diphenyldimethylmethane, bisphenone, diphenyl sulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzoxathiadiazole, benzoxadiazole, benzopyridine, benzopyrazine, benzopyrazidine, benzopyrimidine, benzotriazine, indolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, each of which may also optionally be substituted.

The preferred alkyl groups include the methyl, ethyl, propyl, isopropyl, 1-butyl, 2-butyl, 2-methylpropyl, tert-butyl radical, pentyl, 2-methylbutyl, 1,1-dimethylpropyl, hexyl, heptyl, octyl, 1,1,3,3-tetramethylbutyl, nonyl, 1-decyl, 2-decyl, undecyl, dodecyl, pentadecyl and the eicosyl group.

The preferred cycloalkyl groups include the cyclopropyl, cyclobutyl, cyclopentyl, cyclohexyl, cycloheptyl and the cyclooctyl group, each of which is optionally substituted with branched or unbranched alkyl groups.

The preferred alkanoyl groups include the formyl, acetyl, propionyl, 2-methylpropionyl, butyryl, valeroyl, pivaloyl, hexanoyl, decanoyl and the dodecanoyl group.

The preferred alkoxycarbonyl groups include the methoxycarbonyl, ethoxycarbonyl, propoxycarbonyl, butoxycarbonyl, tert-butoxycarbonyl, hexyloxycarbonyl, 2-methylhexyloxycarbonyl, decyloxycarbonyl or dodecyloxycarbonyl group.

The preferred alkoxy groups include alkoxy groups whose hydrocarbon radical is one of the aforementioned preferred alkyl groups.

The preferred cycloalkoxy groups include cycloalkoxy groups whose hydrocarbon radical is one of the aforementioned preferred cycloalkyl groups.

The preferred heteroatoms which are present in the R¹⁰ radical include oxygen, nitrogen, sulfur, boron, silicon and phosphorus, preference being given to oxygen and nitrogen.

The R¹⁰ radical comprises at least one, preferably at least two, preferentially at least three, heteroatoms.

The R¹⁰ radical in ester compounds of the formula (IV) preferably has at least 2 different heteroatoms. In this case, the R¹⁰ radical in at least one of the ester compounds of the formula (IV) may comprise at least one nitrogen atom and at least one oxygen atom.

Examples of ethylenically unsaturated, polar ester compounds of the formula (IV) include aminoalkyl(meth)acrylates, aminoalkyl(meth)acrylamides, hydroxyalkyl(meth)acrylates, (meth)acrylates of ether alcohols, heterocyclic(meth)acrylates and/or carbonyl-containing (meth)acrylates.

The hydroxyalkyl(meth)acrylates include 2-hydroxypropyl(meth)acrylate, 3,4-dihydroxybutyl(meth)acrylate, 2-hydroxyethyl(meth)acrylate, 3-hydroxypropyl(meth)acrylate, 2,5-dimethyl-1,6-hexanediol(meth)acrylate and 1,10-decanediol(meth)acrylate.

(Meth)acrylates of ether alcohols include tetrahydrofurfuryl(meth)acrylate, methoxyethoxyethyl(meth)acrylate, 1-butoxypropyl(meth)acrylate, cyclohexyloxyethyl(meth)acrylate, propoxyethoxyethyl(meth)acrylate, benzyloxyethyl(meth)acrylate, furfuryl(meth)acrylate, 2-butoxyethyl(meth)acrylate, 2-ethoxy-2-ethoxyethyl(meth)acrylate, 2-methoxy-2-ethoxypropyl(meth)acrylate, ethoxylated(meth)acrylates, 1-ethoxybutyl(meth)acrylate, methoxyethyl(meth)acrylate, 2-ethoxy-2-ethoxy-2-ethoxyethyl(meth)acrylate, esters of (meth)acrylic acid and methoxy polyethylene glycols.

Appropriate carbonyl-containing (meth)acrylates include, for example, 2-carboxyethyl(meth)acrylate, carboxymethyl(meth)acrylate, oxazolidinylethyl(meth)acrylate, N-(methacryloyloxy)formamide, acetonyl(meth)acrylate, mono-2-(meth)acryloyloxyethyl succinate, N-(meth)acryloylmorpholine, N-(meth)acryloyl-2-pyrrolidinone, N-(2-(meth)acryloyloxyethyl)-2-pyrrolidinone, N-(3-(meth)acryloyloxypropyl)-2-pyrrolidinone, N-(2-(meth)acryloyloxypentadecyl)-2-pyrrolidinone, N-(3-(meth)acryloyloxyheptadecyl)-2-pyrrolidinone and N-(2-(meth)acryloyloxyethyl)ethyleneurea.

The heterocyclic(meth)acrylates include 2-(1-imidazolyl)ethyl(meth)acrylate, 2-(4-morpholinyl)ethyl(meth)acrylate and 1-(2-(meth)acryloyloxyethyl)-2-pyrrolidone.

Of particular interest are additionally aminoalkyl(meth)acrylates and aminoalkyl(meth)acrylatamides, for example dimethylaminopropyl(meth)acrylate, dimethylaminodiglykol(meth)acrylate, dimethylaminoethyl(meth)acrylate, dimethylaminopropyl(meth)acrylamide, 3-diethylaminopentyl(meth)acrylate and 3-dibutylaminohexadecyl(meth)acrylate.

In addition, it is possible to use phosphorus-, boron- and/or silicon-containing (meth)acrylates as dispersing units, such as 2-(dimethylphosphato)propyl(meth)acrylate, 2-(ethylenephosphito)propyl(meth)acrylate, dimethylphosphinomethyl(meth)acrylate, dimethylphosphonoethyl(meth)acrylate, diethyl(meth)acryloyl phosphonate, dipropyl(meth)acryloyl phosphate, 2-(dibutylphosphono)ethyl(meth)acrylate, 2,3-butylene(meth)acryloylethyl borate, methyldiethoxy(meth)acryloylethoxysilane, diethylphosphatoethyl(meth)acrylate.

The preferred heterocyclic vinyl compounds include 2-vinylpyridine, 3-vinylpyridine, 2-methyl-5-vinylpyridine, 3-ethyl-4-vinylpyridine, 2,3 dimethyl-5-vinylpyridine, vinylpyrimidine, vinylpiperidine, 9-vinylcarbazole, 3-vinylcarbazole, 4-vinylcarbazole, 1-vinylimidazole, N-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles, particular preference being given to using N-vinylimidazole and N-vinyl pyrrolidone for functionalization.

The monomers detailed above can be used individually or as a mixture.

Of particular interest are especially polymers which comprise ester groups and are obtained using 2-hydroxypropyl methacrylate, 2-hydroxyethyl methacrylate, mono-2-methacryloyloxyethyl succinate, N-(2-methacryloyloxyethyl)ethyleneurea, 2-acetoacetoxyethyl methacrylate, 2-(4-morpholinyl)ethyl methacrylate, dimethylaminodiglycol methacrylate, dimethylaminoethyl methacrylate and/or dimethylaminopropylmethacrylamide.

Special improvements can be achieved with ester groups comprise polymers being obtained using N-vinyl-2-pyrrolidine and/or N-vinyl-2-pyrrolidone.

The dispersing and non-dispersing monomers can be statistically distributed within the ester group comprising polymer. The proportion of dispersing repeat units in a statistical polymer, based on the weight of the polymers comprising ester groups, is preferably in the range from 0% by weight to 20% by weight, more preferably in the range from 1% by weight to 15% by weight and most preferably in the range from 2.5% by weight to 10% by weight.

More preferably, the dispersing repeating unit can be selected from dimethylaminopropylmethacrylamide (DMAPMA) and/or dimethylaminoethylmethacrylate (DMEMA) and the amount of dispersing repeating based on the weight of the polymers comprising ester groups, is preferably in the range from 0.5% by weight to 10% by weight, more preferably in the range from 1.2% by weight to 5% by weight.

More preferably, the dispersing repeating unit can be selected from 2-(4-morpholinyl)ethylmethacrylate (MOEMA), 2-hydroxyethyl(meth)acrylate (HEMA) and/or hydroxypropylmethacrylate (HPMA) and the amount of dispersing repeating based on the weight of the polymers comprising ester groups, is preferably in the range from 2% by weight to 20% by weight, more preferably in the range from 5% by weight to 10% by weight.

According to another aspect of the present invention, the ester group containing polymer may comprise only a low amount of dispersing repeating units. According such aspect, the proportion of the dispersing repeat units is preferably at most 5%, more preferably at most 2% and most preferably at most 0.5%, based on the weight of the polymers comprising ester groups.

According to a preferred embodiment of the present invention, the ester group containing polymer is a graft copolymer having an non-dispersing alkyl(meth)acrylate polymer as graft base and an dispersing monomer as graft layer. Preferably non-dispersing alkyl(meth)acrylate polymer essentially comprises (meth)acrylate monomer units according formulae (I), (II) and (III) as defined above and below. The proportion of dispersing repeat units in a graft or block copolymer, based on the weight of the polymers comprising ester groups, is preferably in the range from 0% by weight to 20% by weight, more preferably in the range from 1% by weight to 15% by weight and most preferably in the range from 2.5% by weight to 10% by weight.

The dispersing monomer preferably is a heterocyclic vinyl compound as mentioned above and below.

According to a further aspect of the present invention the ester group containing polymer is an alkyl(meth)acrylate polymer having at least one polar block and at least one hydrophobic block.

Preferably, the polar block comprises at least three units derived from monomers of the formula (IV) and/or from heterocyclic vinyl compounds, which are bonded directly to one another.

Preferred polymers comprise at least one hydrophobic block and at least one polar block.

The term “block” in this context denotes a section of the polymer. The blocks may have an essentially constant composition composed of one or more monomer units. In addition, the blocks may have a gradient, in which case the concentration of different monomer units (repeat units) varies over the segment length. The polar blocks differ from the hydrophobic block via the proportion of dispersing monomers. The hydrophobic blocks may have at most a small proportion of dispersing repeat units (monomer units), whereas the polar block comprise a high proportion of dispersing repeat units (monomer units).

The polar block may preferably comprise at least 8, especially preferably at least 12 and most preferably at least 15 repeat units. At the same time, the polar block comprise at least 30% by weight, preferably at least 40% by weight, of dispersing repeat units, based on the weight of the polar block. In addition to the dispersing repeat units, the polar block may also have repeat units which do not have any dispersing effect. The polar block may have a random structure, such that the different repeat units have a random distribution over the segment length. In addition, the polar block may have a block structure or a structure in the form of a gradient, such that the non-dispersing repeat units and the dispersing repeat units within the polar block have an inhomogeneous distribution.

The hydrophobic block may comprise a small proportion of dispersing repeat units, which is preferably less than 20% by weight, more preferably less than 10% by weight and most preferably less than 5% by weight, based on the weight of the hydrophobic block. In a particularly appropriate configuration, the hydrophobic block comprises essentially no dispersing repeat units.

The hydrophobic block of the polymer comprising ester groups may have 5 to 100% by weight, especially 20 to 98% by weight, preferably 30 to 95 and most preferably 70 to 92% by weight of repeat units derived from ester monomers having 7 to 15 carbon atoms in the alcohol radical.

In a particular aspect, the hydrophobic block of the polymer comprising ester groups may have 0 to 80% by weight, preferably 0.5 to 60% by weight, more preferably 2 to 50% by weight and most preferably 5 to 20% by weight of repeat units derived from ester monomers having 16 to 4000 carbon atoms in the alcohol radical.

In addition, the hydrophobic block of the polymer comprising ester groups may have 0 to 40% by weight, preferably 0.1 to 30% by weight and more preferably 0.5 to 20% by weight of repeat units derived from ester monomers having 1 to 6 carbon atoms in the alcohol radical.

The hydrophobic block of the polymer comprising ester groups comprises preferably at least 40% by weight, more preferably at least 60% by weight, especially preferably at least 80% by weight and most preferably at least 90% by weight of repeat units derived from ester monomers.

The length of the hydrophobic and hydrophobic blocks may vary within wide ranges. The hydrophobic block preferably possesses a weight-average degree of polymerization of at least 10, especially at least 40. The weight-average degree of polymerization of the hydrophobic block is preferably in the range from 20 to 5000, especially from 50 to 2000.

The proportion of dispersing repeat units, based on the weight of the polymers comprising ester groups, is preferably in the range from 0.5% by weight to 20% by weight, more preferably in the range from 1.5% by weight to 15% by weight and most preferably in the range from 2.5% by weight to 10% by weight. At the same time, these repeat units preferably form a segment-like structure within the polymer comprising ester groups, such that preferably at least 70% by weight, more preferably at least 80% by weight, based on the total weight of the dispersing repeat units, are part of a polar block.

Preferably, the weight ratio of said hydrophobic block and said polar block is in the range from 100:1 to 1:1, more preferably in the range from 30:1 to 2:1 and most preferably in the range from 10:1 to 4:1.

In a preferred embodiment, the polymer used in the method for reducing the halogen content of said polymer is a product of controlled radical polymerization process using halogen containing compounds, especially initiators or transfer groups comprising halogens. These controlled radical polymerization process using halogen containing compounds include ATRP process or similar processes such as Reversible Chain Transfer Catalyzed Polymerization (RTCP) as mentioned in Polymer 49 (2008) 5177-5185 and WO 2009/136510 and U.S. Pat. No. 7,399,814. The disclosures of these documents are enclosed herewith by reference.

Preferably, the initiator or the transferable group comprises Cl, Br and/or I.

The ATRP method was substantially developed by Prof. Matyjaszewski (Matyjaszewski et al., J. Am. Chem. Soc., 1995, 117, p. 5614; WO 97/18247; Science, 1996, 272, p. 866). The ATRP process is based on a redox equilibrium between a growing radical polymer chain present only at low concentration and a transition metal compound in a higher oxidation state (e.g. copper II), and the dormant combination preferably present composed of the polymer chain terminated by a halogen or by a pseudohalogen and the corresponding transition metal compound in a lower oxidation state (e.g. copper I). This applies both to actual ATRP, which is initiated using (pseudo)halogen-substituted initiators and to reverse ATRP as described at a later stage below, in which the halogen is not bonded to the polymer chain until the equilibrium is established.

The ATRP process can be carried out in the form of emulsion polymerization, miniemulsion polymerization, microemulsion polymerization, or suspension polymerization, as well as in the form of solution polymerization.

The initiator used can comprise any compound which has one or more atoms or, respectively, atom groups X which can be transferred by a radical route under the polymerization conditions of the ATRP process. The active group X generally involves Cl, Br, I, SCN, and/or N₃, with Cl, Br and/or I being preferred.

Suitable initiators generally encompass the following formulae:

R^{1′}R^{2′}R^{3′}C—X,R^{1′}(═O)—X,R^{1′}R^{2′}R^{3′}Si—X,R^{1′}NX₂,R^{1′}R^{2′}N—X,(R^{1′})ₙP(O)ₘ—X₃₋ₙ,(R^{1′}O)ₙP(O)ₘ—X₃₋ₙ, and (R^{1′})(R^{2′}O)P(O)ₘ—X,

where X has been selected from the group consisting of Cl, Br, I, OR^{4′}, SR^{4′}, SeR^{4′}, OC(═O)R^{4′}, OP(═O)R^{4′}, OP(═O)(OR^{4′})₂, OP(═O)OR^{4′}, O—N(R^{4′})₂, ON, NC, SON, NCS, OCN, ONO, and N₃ (where R^{4′} is an alkyl group of from 1 to 20 carbon atoms, where each hydrogen atom independently can have been replaced by a halogen atom, preferably fluoride or chloride, or alkenyl of from 2 to 20 carbon atoms, preferably vinyl, or alkenyl of from 2 to 10 carbon atoms, preferably acetylenyl, or phenyl, in which from 1 to 5 halogen atoms or alkyl groups having from 1 to 4 carbon atoms can be present as substituents, or aralkyl, and where R^{1′}, R^{2′}, and R^{3′}, independently of one another, have been selected from the group consisting of hydrogen, halogens, alkyl groups having from 1 to 20, preferably from 1 to 10, and particularly preferably from 1 to 6, carbon atoms, cycloalkyl groups having from 3 to 8 carbon atoms, silyl groups, alkylsilyl groups, alkoxysilyl groups, amine groups, amide groups, COCl, OH, CN, alkenyl groups or alkynyl groups having from 2 to 20 carbon atoms, preferably from 2 to 6 carbon atoms, and particularly preferably allyl or vinyl, oxiranyl, glycidyl, alkenyl or alkenyl groups having from 2 to 6 carbon atoms, which with oxiranyl or glycidyl, aryl, heterocyclyl, aralkyl, aralkenyl(aryl-substituted alkenyl), where aryl is as defined above and alkenyl is vinyl, substituted by one or two C₁-C₆-alkyl groups, in which from one to all of the hydrogen atoms, preferably one, has/have been substituted by halogen (preferably fluorine or chlorine if one or more hydrogen atoms has/have been replaced, and preferably fluorine, chlorine or bromine if one hydrogen atom has been replaced), alkenyl groups having 1 to 6 carbon atoms, substituted by from 1 to 3 substituents (preferably 1) selected from the group consisting of C₁-C₄-alkoxy, aryl, heterocyclyl, ketyl, acetyl, amine, amide, oxiranyl, and glycidyl, and m=0 or 1; m=0, 1 or 2. It is preferable that no more than two of the moieties R^{1′}, R^{2′}, and R^{3′} is/are hydrogen, and it is particularly preferable that at most one of the moieties R^{1′}, R^{2′}, and R^{3′} is hydrogen.

Among the particularly preferred initiators are benzyl halides, such as p-chloromethylstyrene, hexakis(α-bromomethyl)benzene, benzyl chloride, benzyl bromide, 1-bromo-i-phenylethane and 1-chloro-i-phenylethane. Particular preference is further given to carboxylic acid derivatives halogenated at the α position, e.g. propyl 2-bromopropionate, methyl 2-chloropropionate, ethyl 2-chloropropionate, methyl 2-bromopropionate, or ethyl 2-bromoisobutyrate. Preference is also given to tosyl halides, such as p-toluenesulfonyl chloride; alkyl halides, such as tetrachloromethane, tribromoethane, 1-vinylethyl chloride, or 1-vinylethyl bromide; and halogen derivatives of phosphoric esters, e.g. dimethylphosphonyl chloride.

One particular group of the initiators suitable for the synthesis of block copolymers is provided by the macroinitiators. A feature of these is that from 1 to 3, preferably from 1 to 2, and very particularly preferably one, moiety from the group of R^{1′}, R^{2′}, and R^{3′} involves macromolecular moieties. These macromoieties can have been selected from the group of the polyolefins, such as polyethylene or polypropylene; polysiloxanes; polyethers, such as polyethylene oxide or polypropylene oxide; polyesters, such as polylactic acid, or from other known end group functionalizable macromolecules. The molecular weight of each of these macromolecular moieties can be from 500 to 100 000, preferably from 1000 to 50 000, and particularly preferably from 1500 to 20 000. It is also possible, for the initiation of the ATRP, to use said macromolecules which at both ends have groups suitable as initiator, e.g. in the form of a bromotelechelic compound. Using macroinitiators of this type it is possible to construct ABA triblock copolymers.

Another important group of the initiators is provided by the bi- or polyfunctional initiators. Using polyfunctional initiator molecules it is, for example, possible to synthesize star polymers. Using bifunctional initiators, it is possible to prepare tri- or pentablock copolymers and telechelic polymers. Bifunctional initiators that can be used are R*O₂C—CHX—(CH₂)ₙ—CHX—CO₂R*, R*O₂C—C(CH₃)X—(CH₂)ₙ—C(CH₃)X—CO₂R*, R*O₂C—CX₂—(CH₂)ₙ—CX₂—CO₂R*, R*C(O)—CHX—(CH₂)ₙ—CHX—C(O)R*, R*C(O)—C(CH₃)X—(CH₂)ₙ—C(CH)₃X—C(O)R*, R*C(O)—CX₂—(CH₂)ₙ—CX₂—C(O)R*, XCH₂—CO₂—(CH₂)ₙ—OC(O)CH₂X, CH₃CHX—CO₂—(CH₂)ₙ—OC(O)CHXCH₃, (CH₃)₂CX—CO₂—(CH₂)ₙ—OC(O)CX(CH₃)₂, X₂CH—CO₂—(CH₂)ₙ—OC(O)CHX₂, CH₃CX₂—CO₂—(CH₂)ₙ—OC(O)CX₂CH₃, XCH₂C(O)C(O)CH₂X, CH₃CHXC(O)C(O)CHXCH₃, XC(CH₃)₂C(O)C(O)CX(CH₃)₂, X₂CHC(O)C(O)CHX₂, CH₃CX₂C(O)C(O)CX₂CH₃, XCH₂—C(O)—CH₂X, CH₃—CHX—C(O)—CHX—CH₃, CX(CH₃)₂—C(O)—CX(CH₃)₂, X₂CH—C(O)—CHX₂, C₆H₅—CHX—(CH₂)ₙ—CHX—C₆H₅, C₆H₅—CX₂—(CH₂)ₙ—CX₂—C₆H₅, C₆H₅—CX₂—(CH₂)ₙ—CX₂—C₆H₅, o-, m-, or p-XCH₂-Ph-CH₂X, o-, m-, or p-CH₃CHX-Ph-CHXCH₃, o-, m-, or p-(CH₃)₂CX-Ph-CX(CH₃)₂, o-, m-, or p-CH₃CX₂-Ph-CX₂CH₃, o-, m-, or p-X₂CH-Ph-CHX₂, o-, m-, or p-XCH₂—CO₂-Ph-OC(O)CH₂X, o-, m-, or p-CH₃CHX—CO₂-Ph-OC(O)CHXCH₃, o-, m-, or p-(CH₃)₂CX—CO₂-Ph-OC(O)CX(CH₃)₂, CH₃CX₂—CO₂-Ph-OC(O)CX₂CH₃, o-, m-, or p-X₂CH—CO₂-Ph-OC(O)CHX₂, or o-, m-, or p-XSO₂-Ph-SO₂X (X being chlorine, bromine, or iodine; Ph being phenylene (C₆H₄); R* representing an aliphatic moiety of from 1 to 20 carbon atoms, of linear, branched, or cyclic structure, which can be saturated or have mono- or polyunsaturation, and which can contain one or more aromatic systems or can be free from aromatic systems, and n is a number from 0 to 20). It is preferable to use 1,4-butanediol di(2-bromo-2-methylpropionate), ethylene glycol 1,2-di(2-bromo-2-methylpropionate), diethyl 2,5-dibromoadipate, or diethyl 2,3-dibromomaleate. The subsequent molecular weight is the result of the initiator to monomer ratio, if all of the monomer is converted.

The molar ratio of transition metal to monofunctional initiator is generally in the range from 0.01:1 to 10:1, preferably in the range from 0.1:1 to 3:1, and particularly preferably in the range from 0.5:1 to 2:1, with no intention of any resultant restriction.

In order to raise the solubility of the metals in organic solvents and simultaneously to avoid the formation of organometallic compounds which are more stable and therefore less active in polymerization, ligands are added to the system. The ligands also facilitate the abstraction of the transferable atom group by the transition metal compound. A list of known ligands is found by way of example in WO 97/18247, WO 97/47661, or WO 98/40415. The compounds used as ligand mostly have one or more nitrogen atoms, oxygen atoms, phosphorus atoms, and/or sulfur atoms as coordinative constituent. Particular preference is given here to nitrogen-containing compounds. Very particular preference is given to nitrogen-containing chelating ligands. Examples that may be mentioned are 2,2′-bipyridine, N,N,N″,N″,N″-pentamethyldiethylenetriamine (PMDETA), tris(2-aminoethyl)amine (TREN), N,N,N″,N″-tetramethylethylenediamine, or 1,1,4,7,10,10-hexamethyltriethylenetetramine. The person skilled in the art will find in WO 98/40415 useful indications of the selection and combination of the individual components.

These ligands can form coordination compounds in situ with the metal compounds, or they can be first prepared in the form of coordination compounds and then added to the reaction mixture.

The ratio of ligand (L) to transition metal depends on the number of coordination sites occupied by the ligand and on the coordination number of the transition metal (M). The molar ratio is generally in the range from 100:1 to 0.1:1, preferably from 6:1 to 0.1:1, and particularly preferably from 3:1 to 1:1, with no intention of any resultant restriction.

Usually an ATRP process is catalysed by a transition metal compound selected from copper compounds, iron compounds, cobalt compounds, chromium compounds, manganese compounds, molybdenum compounds, silver compounds, zinc compounds, palladium compounds, rhodium compounds, platinum compounds, ruthenium compounds, iridium compounds, ytterbium compounds, samarium compounds, rhenium compounds and/or nickel compounds.

If a copper compound has been chosen as catalyst for such an ATRP process, said copper compound can be preferably added to the system in the form of Cu₂O, CuBr, CuCI, CuI, CuN₃, CuSCN, CuCN, CuNO₂, CuNO₃, CuBF₄, Cu(CH₃COO) and/or Cu(CF₃COO), prior to the start of the polymerization.

An alternative to the ATRP described is provided by a variant of the same: in what is known as reverse ATRP, compounds in higher oxidation states, such as CuBr₂, CuCl₂, CuO, CrCl₃, Fe₂O₃, or FeBr₃ can be used. In these instances, the reaction can be initiated with the aid of traditional radical generators, such as AIBN. Here, the transition metal compounds are first reduced, since they are reacted with the radicals generated by the traditional radical generators. Reverse ATRP was described inter alia by Wang and Matyjaszewski in Macromolekules (1995), vol. 28, pp. 7572ff.

A variant of reverse ATRP is provided by the additional use of metal in the oxidation state zero. The reaction rate is accelerated by what is assumed to be comproportionation with the transition metal compounds of the higher oxidation state. More details of this process are described in WO 98/40415.

According to a special aspect of the present invention, polymers based on ethyl vinyl acetate, which has been preferably synthesized by the ATRP process, can also be used as an ester group containing polymer for the disclosed method to reduce the halogen content in the final polymer. Preferred polymers based on ethyl vinyl acetate are described in EP 0 739 971 B1, EP 0 721 492 B2 and EP 0 741 181 B1. The documents EP 0 739 971 B1 filed with the European Patent Office Jun. 29, 1993 under the Application number 96202136.6; EP 0 721 492 B2 filed with the European Patent Office Jul. 22, 1994 under the Application number 94924280.4 and EP 0 741 181 B1 filed with the European Patent Office Jun. 29, 1993 under the Application number 96202137.4 are enclosed herein by reference.

In a preferred embodiment of the present invention, a polymerization inhibitor is subsequently added at the end of said ATRP process in the same reaction vessel to conduct a one-pot reaction.

Preferably, the polymer used in the method of the present invention is reacted with the polymerization inhibitor in a solvent. The term solvent is to be understood here in a broad sense.

In a preferred embodiment of the present invention, the polymer used in the method of the present invention is reacted with the polymerization inhibitor in a nonpolar solvent. These include hydrocarbon solvents, for example aromatic solvents such as toluene, benzene and xylene, saturated hydrocarbons, for example cyclohexane, heptane, octane, nonane, decane, dodecane, which may also be present in branched form.

Particularly preferred solvents are mineral oils, diesel fuels of mineral origin, natural vegetable and animal oils, biodiesel fuels and synthetic oils (e.g. ester oils such as dinonyl adipate), and also mixtures thereof. Among these, very particular preference is given to mineral oils and mineral diesel fuels.

These solvents may be used individually and as a mixture.

The duration of the post polymerization reaction of the polymer with the inhibitor depends on the parameters described in the foregoing. It has been found that an efficient decrease of the halogen content in the polymer can be achieved after at least 30 min, preferably at least 1 hour.

The molar ratio of polymerization inhibitor to halogen being part of the polymer is not very critical and astonishingly, the present invention also works with small amount of polymerization inhibitor. High amounts of polymerization inhibitor lead to a quick and complete removal of halogen. However, with regard to economic aspects, low amounts of polymerization inhibitor can also lead to adequate results. Preferably, the molar ratio of the polymerization inhibitor to halogen being part of the polymer can range from 0.2:1 to 10:1, preferably from 0.4:1 to 5:1, and more preferably from 1:1 to 3:1.

The polymer used in the method of the present invention is generally reacted at a temperature in the range of −20° to 200° C., preferably 30° to 180° C., and more preferably 60° to 140° C. The post polymerization reaction may be carried out at standard pressure, reduced pressure or elevated pressure.

According to a preferred embodiment of the present invention the polymer composition being reacted with a polymerization inhibitor can be treated with any known purification procedure in order to reduce the content of transition metals or small molecules comprising halogen atoms such as chromatography, filtration, centrifugation or dialysis.

In a preferred embodiment of the present invention, the polymer being reacted with a polymerization inhibitor is purified through filtration with an adsorbent or ion exchange resin, in order to reduce the halogen content, in particular the bromine content, of the resulting polymer containing product.

Filtration is known per se and is described, for example, in Ullmann's Encyclopedia of Industrial Chemistry, Fifth Edition, keyword “filtration”. The composition is preferably purified at a pressure difference in the range from 0.1 to 50 bar, preferably from 1 to 10 bar and particularly preferably from 1.5 to 2.5 bar, using a filter having a mesh opening in the range from 0.01 μm to 1 mm, preferably from 1 μm to 100 μm and particularly preferably from 10 μm to 100 μm. These figures serve only as a guide, since the purification is also dependent on the viscosity of the solvent and the particle size of the precipitate.

Preferably, a filtration aid or an adsorbent can be used to improve the filtration results. The adsorbents and/or filtration aids are known from the prior art and preferably selected from the group of silica and/or aluminum oxide, organic polyacids such as absorbent clay and a diatomaceous filter aid.

The filtration takes place in a similar temperature range as the polymerization, with the upper limit being dependent on the stability of the polymer. The lower limit is imposed by the viscosity of the solution.

The polymer composition prepared in this way can be used without further purification, for example as additive in lubricating oils. Furthermore, the polymer can be isolated from the composition. For this purpose, the polymers can be separated out from the composition by precipitation.

It is characteristic of the method according to the present invention that the halogen content in the polymer is eliminated at least partly hereby, wherein the term partly can mean a reduction of the content by, for example, 5 wt %, in each case relative to the starting halogen content.

In preferred embodiments of the inventive method, the reduction of the halogen content is much larger, and so the halogen content is preferably reduced to 60 wt %, particularly preferably to 30 wt % and most particularly preferably 5 wt %, in each case relative to the starting halogen content.

Polymers obtainable preferably by the method of the present invention preferably have a halogen content of smaller than or equal to 1000 ppm, preferably smaller than or equal to 600 ppm, more preferably smaller than or equal to 200 ppm and particularly preferably smaller than or equal to 100 ppm, relative to the total weight of the composition.

Having generally described this invention, a further understanding can be obtained by reference to certain specific examples which are provided herein for purposes of illustration only, and are not intended to be limiting unless otherwise specified.

### EXAMPLES AND COMPARATIVE EXAMPLE

### Inventive Example 1

### TEMPO Treatment

A reaction mixture was prepared by blending 469 grams of laurylmethacrylate (LMA) and 70 grams of methylmethacrylate (MMA) with 74 grams of mineral oil in a 1-liter 4 necked flask equipped with a sickle-shaped stirrer, reflux condenser, thermocouple, and nitrogen sweep. The reaction mixture was inerted for 30 minutes with the nitrogen sweep. 5.8 grams of PMDETA (1 eq.) and 0.72 grams (0.15 eq.) of copper (I) bromide were added, and the mixture was heated to 70° C. As soon as the mixture reached the desired temperature, 6.52 grams of ethyl 2-bromoisobutyrate (EBIB, 1 eq.) was added as a single shot. The temperature was then increased to 95° C.

4 hours after the addition of the EBIB initiator, the nitrogen sweep was terminated and 2.6 grams of 2,2,6,6-tetramethylpiperidin-1-oxyl (TEMPO) was added as a single shot. The mixture was agitated for 60 minutes. The reaction was then diluted by addition of 123.5 grams of mineral oil and allowed to mix at 95° C. overnight.

The polymer solution was filtered using absorbent clay and a diatomaceous filter aid.

Alternatively, the polymer was isolated through dialysis with heptane, filtered to remove catalyst salts, solvent stripped, and finally rediluted with mineral oil.

The final samples were analyzed by GPC and residual bromine and copper was measured using x-ray fluorescence. Results are summarized in Table 1.

### Inventive Example 2

### 4-Hydroxy Tempo Treatment

Reaction and product purification was run under the same conditions as provided in Example 1. However, 1.44 grams of 4-hydroxy-2,2,6,6-tetramethylpiperidin-1-oxyl(4-Hydroxy-TEMPO) was added as a single shot 4 hours after addition of the EBIB initiator (instead of TEMPO). Results are summarized in Table 1.

### Inventive Example 3

### Cupferron Treatment

Reaction and product purification was run under the same conditions as provided in Example 1. However, 2.64 gm of cupferron [ammonium salt of N-nitroso-N-phenylhydroxylamine] (0.50 eq) was added as a single shot 4 hours after addition of the EBIB initiator. Results are summarized in Table 1.

### Inventive Example 4

### Cupferron Treatment

Reaction and product purification was run under the same conditions as provided in Example 1. However, 1.32 gm of cupferron [ammonium salt of N-nitroso-N-phenylhydroxylamine] (0.25 eq) was added as a single shot 4 hours after addition of the EBIB initiator. Results are summarized in Table 1.

### Inventive Example 5

### Ionol Treatment

Reaction and product purification was run under the same conditions as provided in Example 1. However, 0.50 eq of Ionol[2,6-ditert-butyl-4-methylphenol] was added as a single shot 4 hours after addition of the EBIB initiator. Results are summarized in Table 1.

### Inventive Example 6

### MEHQ Treatment

Reaction and product purification was run under the same conditions as provided in Example 1. However, 0.50 eq of MEHQ [hydroquinone monomethyl ether] was added as a single shot 4 hours after addition of the EBIB initiator. Results are summarized in Table 1.

### Comparative Example

### No Post-Treatment

A reaction mixture was prepared by blending 469 grams LMA and 70 grams MMA with 74 grams of mineral oil in a 1-liter 4 necked flask equipped with a sickle-shaped stirrer, reflux condenser, thermocouple, and nitrogen sweep. The reaction mixture was inerted for 30 minutes with the nitrogen sweep. 5.8 grams of PMDETA (1 eq.) and 0.72 grams (0.15 eq.) of copper (I) bromide were added, and the mixture was heated to 70° C. As soon as the mixture reached the desired temperature, 6.52 grams of EBIB (1 eq.) was added as a single shot. The temperature was then increased to 95° C. 4 hours after the addition of the EBIB initiator, the reaction was diluted by addition of 123.5 grams of mineral oil and allowed to mix for 60 minutes.

The polymer solution was filtered using absorbent clay and a diatomaceous filter aid. Alternatively, the polymer was isolated through dialysis with heptane, filtered to remove catalyst salts, solvent stripped, and finally rediluted with mineral oil.

The final samples were analyzed by GPC and residual bromine and copper was measured using x-ray fluorescence.

Results are summarized in Table 1.

TABLE 1
Effect of Post Reaction Treatments on Residual Bromine

| | | Molar | Bromine | Copper |
|---|---|---|---|---|
| Example | Treatment | eq. * | (ppm) | (ppm) |
| 1 - Filtered | TEMPO | 0.5 | 118 | 3 |
| 1 - Dialyzed | TEMPO | 0.5 | 34 | 5 |
| 2 - Filtered | 4HT | 0.25 | 112 | 6 |
| 3 - Filtered | Cupferron | 0.5 | 98 | 5 |
| 4 - Filtered | Cupferron | 0.25 | 187 | 6 |
| 5 - Filtered | Ionol | 0.5 | 273 | 5 |
| 6 - Filtered | MEHQ | 0.5 | 313 | |
| Comparitive Example - | none | | 940 | |
| Filtered | | | | |
| Comparitive Example - | none | | 900 | 8 |
| Dialyzed | | | | |

* Molar equivalents based on moles of EBIB charged

Table 1 demonstrates that the comparative examples, wherein a polymerization process using generally known parameters has been executed, but without treating the final polymer by a polymerization inhibitor, have been led to polymers having very high residual halogen, in particular bromine, contents (940 and 900 ppm). The obtained difference caused by the polymer purification and/or isolating procedure in form of executing a filtration or a dialysis plays solely a minor role exhibiting a total difference of 40 ppm.

The inventive examples 1 and 2 using TEMPO and a TEMPO derivative, respectively, in contradiction prove a tremendous decrease of the residual halogen, in particular bromine, content to 118 ppm in Example 1 using a TEMPO post reaction treatment, and to 112 ppm in Example 2 using a TEMPO derivative post reaction treatment; both using the above-mentioned filtration procedure as polymer work-up process. Example 1 using a dialysis polymer work-up has even proven to be even more effective to reduce the already strongly reduced halogen, in particular bromine, content further down to 34 ppm.

Thus, table 1 clearly exhibits that the object of the present invention to investigate a suitable method to reduce the halogen content of a polymer without being limited by the above-discussed drawbacks of the known prior art has been successfully solved by the claimed method.

1. A method for reducing the halogen content of a polymer, characterized in that the polymer is reacted with a polymerization inhibitor.

2. The method according to claim 1 wherein said polymer is a product of controlled radical polymerization process using halogen containing compounds.

3. The method as claimed in claim 2, wherein said polymer is the product of an ATRP (atom transfer radical polymerization) process

4. The method as claimed in claim 3, wherein said ATRP process is catalysed by a transition metal compound selected from copper compounds, iron compounds, cobalt compounds, chromium compounds, manganese compounds, molybdenum compounds, silver compounds, zinc compounds, palladium compounds, rhodium compounds, platinum compounds, ruthenium compounds, iridium compounds, ytterbium compounds, samarium compounds, rhenium compounds and/or nickel compounds.

5. The method as claimed in claim 4, wherein said copper compound was added to the system in the form of Cu₂O, CuBr, CuCI, CuI, CuN₃, CuSCN, CuCN, CuNO₂, CuNO₃, CuBF₄, Cu(CH₃COO) and/or Cu(CF₃COO), prior to the start of the polymerization.

6. The method as claimed in one of the preceding claims 2 to 5, wherein an initiator containing Cl, Br and/or I is used.

7. The method as claimed in claim 6, wherein the initiator is a benzyl halide, a carboxylic acid derivative halogenated at the α position, and/or a tosyl halide.

8. The method as claimed in claim 7 where the resulting polymer is terminated with a halogen obtained as a result of the controlled radical process used to produce said polymer.

9. The method as claimed in one of the preceding claims 2 to 8, wherein a polymerization inhibitor is subsequently added at the end of said controlled radical polymerization process in order to remove terminal halogen from the polymer product.

10. The method as claimed in one of the preceding claims 2 to 9 where the polymerization inhibitor is added in the same reaction vessel to conduct a one-pot reaction.

11. The method according to at least one of the preceding claims wherein said polymerization inhibitor is of the class typically used as effective polymerization inhibitors for the preparation and/or synthesis of styrene, vinyl acetate, alkyl methacrylates, alkyl acrylates.

12. The method according to at least one of the preceding claims wherein said polymerization inhibitor is an aromatic compound.

13. The method according to claim 12 wherein said aromatic compound is a phenolic compound.

14. The method according to at least one of the preceding claims wherein polymerization inhibitor comprises a stabilized radical.

15. The method according to at least one of the preceding claims wherein polymerization inhibitor is a nitrogen containing compound.

16. The method according to claim 15 wherein said nitrogen containing compound is a nitroso compound.

17. The method according to claim 15 wherein said nitrogen containing compound is an N-oxyl compound.

18. The method according to at least one of the preceding claims wherein said polymer is reacted at a temperature in the range of 30 to 200° C.

19. The method according to at least one of the preceding claims wherein said polymer is reacted with said polymerization inhibitor for at least 1 hour.

20. The method according to at least one of the preceding claims wherein said polymer is reacted with said polymerization inhibitor in a solvent.

21. The method according to claim 20 wherein said solvent is a nonpolar solvent.

22. The method according to at least one of the preceding claims wherein the molar ratio of polymerization inhibitor to halogen being part of the polymer ranges from 0.1:1 to 1:1.

23. The method according to at least one of the preceding claims wherein the polymer being reacted with a polymerization inhibitor is purified through filtration with an adsorbent or ion exchange resin, in order to reduce the halogen content of the polymer.
